(19) United States
(12) Patent Application Publication
(10) Pub. No.: US 2016/0045844 A1
(43) Pub. Date: Feb. 18, 2016

(54) Pulsed Backwash Method and Apparatus

(71) Applicant: Samuel N. Tyler, Fairhaven, MA (US)

(72) Inventor: Samuel N. Tyler, Fairhaven, MA (US)

(21) Appl. No.: 14/824,494

(22) Filed: Aug. 12, 2015

Related U.S. Application Data
(60) Provisional application No. 62/037,039, filed on Aug. 13, 2014.

(51) Int. Cl. B01D 29/68

(52) U.S. Cl. CPC B01D 29/68

(57) ABSTRACT

A system and method for determining and controlling backwash pulsing through a filter medium. The backwash pulsing may be determined by the type of filter medium and/or the condition of the filter medium.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/037,039, entitled “Pulsed Backwash Method and Apparatus”, naming Samuel N. Tyler as inventor, filed 13 Aug. 2014.

### BACKGROUND

1. Field of Use

This invention relates to the art of filtering particulate solids and other deleterious matter from liquids, and more specifically, to an improved method for improving the filtering capacity of a granular medium filter such as a sand filter. Very effective wastewater filters have been developed and described in applicant's prior U.S. Pat. Nos. 3,459,302; 3,516,930; 3,587,861; 3,792,773; 3,817,378; 3,840,117; 4,032,443; 4,627,923; 4,818,414 and Re. 28,458. These patents are incorporated by reference herein to the general art to which the present invention is directed.

2. Description of Prior Art (Background)

Granular medium filters such as sand filters are widely used to remove particulate material and other deleterious matter from wastewaters, potable water supplies, and the like. Such filters trap fine particulate matter within the interstices of the filtering medium, while particles larger in size than the interstices are separated as a layer on the filter medium surface. Eventually, the flow of water through the filter bed is hindered by these trapped and separated solids so that the liquid level above the bed rises. This increased resistance to the movement of liquid through the filter medium bed is a result of reduction in porosity of the bed medium.

The trapped and separated materials are removed periodically by stopping the flow of influent water and backwashing the filter bed with previously-filtered or unfiltered water. The filter normally is backwashed when resistance to flow through the filter bed results in the liquid above the filter bed rising to a predetermined level.

Extending the filtration time between backwashing has several advantages. Several methods have been used to prolong the filter run length between backwashes, without using additional filter area. Ross U.S. Pat. No. 3,459,302 discloses a granular medium filter in which currents are created in the liquid above the filter bed surface by an air diffuser. These currents sweep across the surface, removing solids trapped at the medium surface, and maintain them in suspension in the liquid above the filter surface. This technique to increase filter capacity and filter bed porosity is termed “air scour”

Another means for reducing the frequency of backwashing is described in Ross U.S. Pat. No. 3,817,378. In this reference, at the time filter bed porosity decreases due to separated solids, and liquid accumulates above the filter bed, volumes of air are forced upward through the medium in intermittent pulses of short duration. Some variations of this procedure are known as “air pulse”. A portion of the filtered solids is forced into liquid suspension above the filter bed, while another portion is concentrated by surface medium movement into localized sites within the bed itself. Thus, some of the solids are “stored” within the filter bed, reducing the quantity of solids which increase the flow resistance at the bed suffice. This filter cleaning operation is generally repeated a number of times between backwashes, greatly extending the filtration time before backwashing is required.

A variation of the “air scour” and “air pulse” design is disclosed in Ross U.S. Pat. No. 4,627,923. A plurality of hydraulic jets within the filter bed employ filtered liquid to pulse the granular bed medium. Hydraulic jets above the filter bed also create currents in the liquid to maintain solids in suspension during the filter run.

Garzonetti, in U.S. Pat. No. 4,693,831, discloses a method for controlling the pulsing of a granular medium filter based on determination of the rise rate of liquid level above the filtration medium. Either air or liquid is used to pulse the filter bed.

In U.S. Pat. No. 4,859,330 Pauwels discloses a traveling bridge device with air scour and backwash means for successively cleaning each of a plurality of filter cells formed in a filtration tank.

As currently practiced, the “air scour” system or the “above bed hydraulic jet” system are activated when the liquid level above the filter bed rises to activate a first level detector. This detector is generally situated at a low position in the filter tank. Activation of either of these systems results in removing some of the solids from the filter surface and suspension of these solids in the liquid above the filter bed. As additional solids accumulate on and in the filter bed, the liquid level above the bed rises further to activate a second level detector. The second detector activates the “air pulse” or hydraulic jet pulse system. The “air pulse” or hydraulic jet pulse system results in volumes of air or liquid being forced upward through the medium in intermittent pulses of short duration. A portion of the filtered solids is forced into liquid suspension, while another portion is concentrated by surface medium movement into localized sites within the bed itself. Thus, some of the solids are “stored” within the filter bed, reducing the quantity of solids which produce the flow resistance at the bed surface. Additional pulses are initiated on a timed and timely basis at preset intervals of a few to many minutes, depending upon the expected solids loading and hydraulic loading.

Backwashing is typically initiated when a third level detector, located at a level higher than the first and second level detectors in the filter tank, is activated by the rising liquid level. Influent wastewater flow ceases and filtrate is forced up through the filter medium bed at a fluidizing or sub-fluidizing velocity. The backwash water carries the collected particles out of the filter cell, and generally back to the head of the treatment plant. The backwash flow ceases and the washed granular medium settles back to form a filter bed and another filtration cycle commences.

During the period of the air pulse or jet pulse in a filter cell, downward flow through the filter medium is temporarily retarded, and the liquid level, over the medium bed will rise. The rate of rise is a function of the rate of inflow to the filter cell. For example, with an influent flow rate to a filter cell of approximately 7.5 gallons/min/ft2, the rate of level rise is approximately 12 inches per minute. A pulse period 30 seconds in length results in the liquid level rising 6 inches. This level rise may not be recovered during the period subsequent to the pulse period, should the influent rate be very high. The liquid level may be raised even further by subsequent pulse cycles, and prematurely activate the backwash cycle. To overcome this and other problems several modifications to the filter systems described above have been invented.

### BRIEF SUMMARY

The foregoing and other problems are overcome, and other advantages are realized, in accordance with the presently preferred embodiments of these teachings. The invention includes an electronic controller that is activated when a filter goes into a backwash cleaning cycle. The controller turns a solenoid valve on and off at a set desired sequence and then a set run time throughout the backwash cycle. The results of this action allows for longer filter media life and also better water flow through the media bed.

The invention is also directed towards a method for pulsing backwash through a filter media. The method includes selecting a filter media type and selecting a pulse repetition time (PRT) and duty cycle for pulsing backwash through the filter media via a filter valve. In addition, PRT and duty cycle is selected according to the filter media type.

The invention is also directed towards a periodic or aperiodic method for determining a pulse backwash cycle. The method includes selecting a filter type and determining at least one first pulse repetition time (PRT) for the filter type. The method also includes determining a first duty cycle for the at least one first PRT. The method includes determining at least one second PRT for the filter type and determining a second duty cycle for the at least one second PRT. In addition, a tᵣᵤₙ time for continuous backwashing the filter type is determined.

The present invention is an improved method and apparatus for operating a down-now granular medium filter. The effective filtration time between backwashes is increased, and the filter medium life is extended.

This invention is applicable to filters which are adapted for periodic back washing. Such filters include a granular medium filter bed with an upper and lower surface.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a pictorial illustration of a pulsed backwash system in filter mode in which the invention is implemented;

FIG. 2 is a pictorial illustration of a pulsed backwash system in backwash mode in accordance with the invention shown in FIG. 1;

FIG. 2A is a graphical representation of the pulse backwash cycle in accordance with the invention shown in FIG. 1 and FIG. 2;

FIG. 2B is a method flow chart for one method of determining the pulse backwash cycle shown in FIG. 2A;

FIG. 2C is an alternate method flow chart for determining the pulse backwash cycle shown in FIG. 2A; and

FIG. 3 is a pictorial illustration of a pulsed backwash system with optional sensors and in filter mode in which the invention is implemented in accordance with the invention shown in FIG. 1.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may he included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

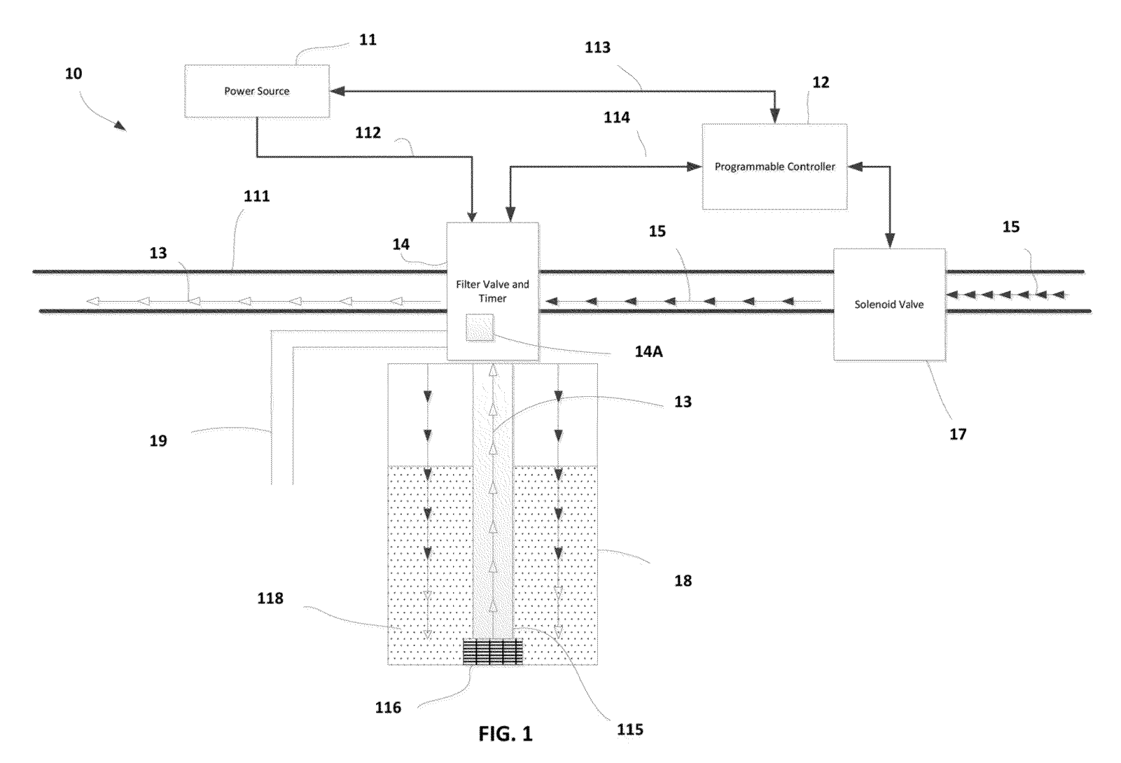

Referring now to FIG. 1 there is shown a pictorial illustration of a pulsed backwash system 10 in filter mode in which the invention is implemented. Included within pulsed backwash system 10 is power source 11, programmable controller 12, filter valve and timer 14, solenoid valve 17, filter assembly 18, and backwash drain 19.

Power source 11 may be any suitable power source for providing power directly to controller 12 and filter valve and timer 12, and via controller 12 to solenoid valve 17. It will be appreciated that power source 11 may be alternating current (AC) power and/or direct current (DC) power as required.

Programmable controller 12 may be any suitable programmable controller for controlling the on/off times of filter valve and timer 14 and solenoid valve 17. An operating system is executed on programmable controller 12 and is used to execute programmable code to control various components within pulsed backwash system 10. The operating system may be any suitable commercially available operating system. In addition, an object oriented programming system such as Java may run in conjunction with the operating system and provide calls to the operating system from Java programs or applications. “Java” is a trademark of Sun Microsystems, Inc. Instructions for the operating system, the object-oriented operating system, and applications or programs may be located on fixed or removable storage devices.

Still referring to FIG. 1, programmable controller 12 may also provide manual operation of system 12 through onboard switches. In addition, programmable controller 12 may also respond to signals provided by filter valve and timer 14. For example, an effluent or water quality sensor included with filter valve and timer 14 may be used to determine when a backwash cycle should be initiated. Likewise, similar sensors may be used to determine when a backwash cycle should be concluded.

FIG. 1 also shows solenoid valve 17. In normal operation solenoid valve 17 is in the on or open position, allowing unfiltered fluid 15 (usually water) to flow through pipe 111 to filter assembly 18 via filter valve and timer 14.

Unfiltered water or fluid 15 travels through filter media 118 and particulates are trapped by filter media 118. Filter media 118 may be any suitable filter media such as, for example, sand. Other suitable filter media 118 may be granular activated carbon for chlorine and chloramine reduction, taste/odor improvement, and general chemical reduction. Carbon can also remove sediment and iron if the iron is pretreated properly. It is the most commonly used medium for hydrogen sulfide reduction. Granular carbon is the preferred treatment for many chemical contaminants. It is perhaps the most versatile and universal of filter media.

Another suitable filter media 118 may be, for example, a granular filter media manufactured from a type of natural pumice mineral coated with manganese oxide. Such a filter may be used for reduction of iron and manganese. Calcite: To increase the pH of acidic water.

Another suitable filter media 118 may be, for example, FILOX. A natural mined mineral, FILOX is known for high level iron removal and reduction of hydrogen sulfide odors. FILOX is very dense and requires frequent and intense backwashing.

Still referring to FIG. 1, filter media 118 filters water 15 such that filtered water 13 enters riser tube 115 through sieve basket 116 through filter valve and timer 14 to continue downstream pipe 111 as filtered water 13.

In one embodiment controller 12 may initiate a pulse backwash cycle with an on or open command to the filter valve 14 and timer 14A. Controller 12 may send to start command tₒₙ and/or duration time to filter valve 14 and timer 14A. Until the controller sends a stop command t_{off} or the duration expires the filter valve allows backwash flow as described herein.

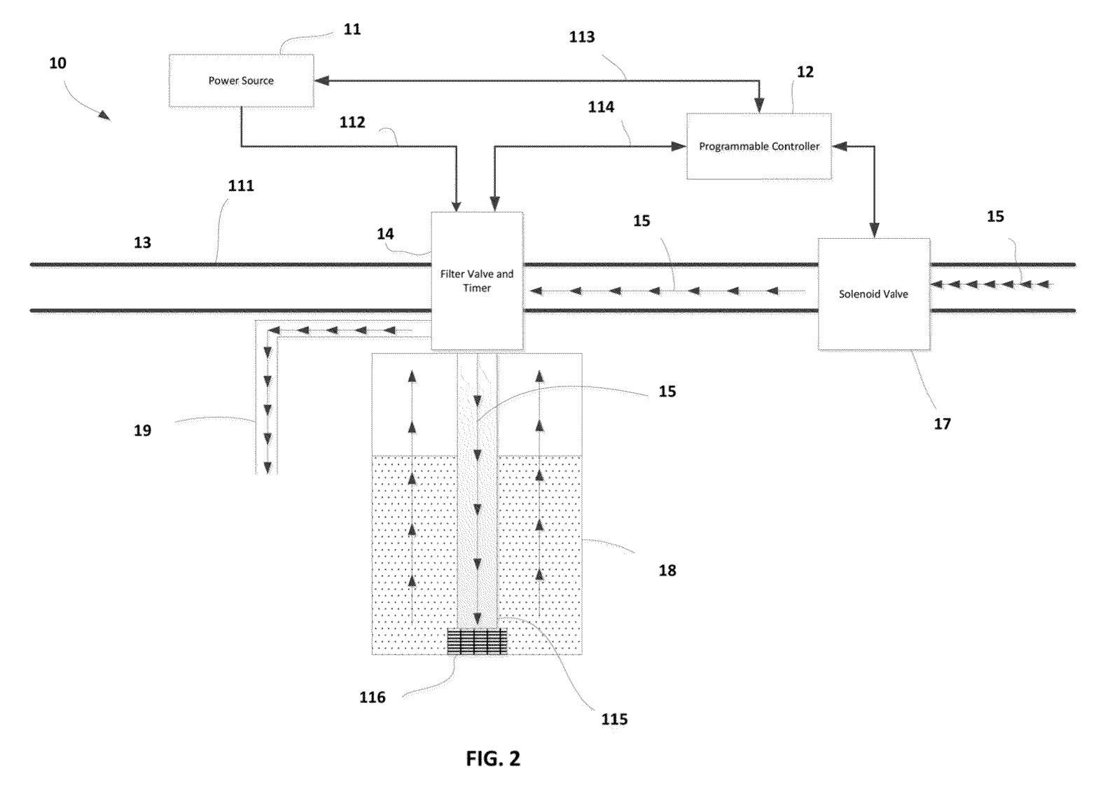

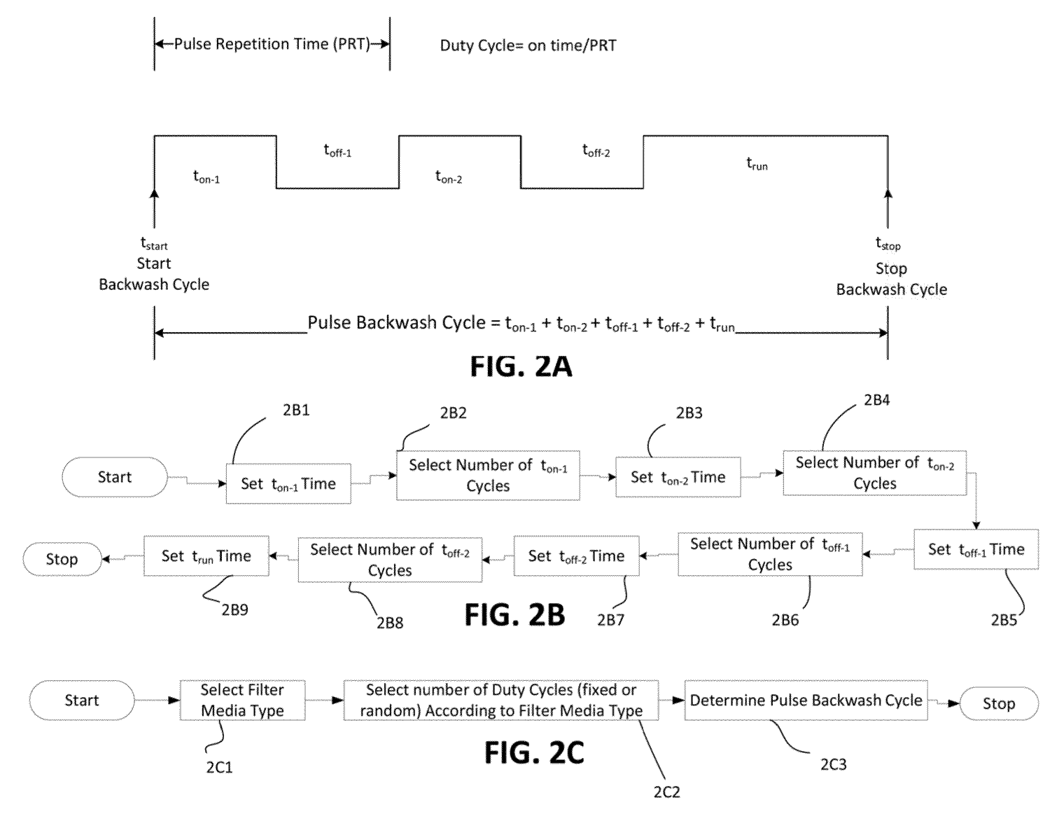

Referring also to FIG. 2 there is shown a pictorial illustration of the pulsed backwash system 10 in backwash mode in accordance with the invention shown in FIG. 1.

During a backwash operation filter valve and timer 14 reverses flow of fluid 15 down through riser tube 115, up through filter media 118 and out through drain 19. During the backwash operation solenoid valve 17 is opened and closed repeatedly by controller 12. When the solenoid valve is closed pressure in the vessel 18 is reduced to zero psi. When the solenoid valve opens, the inrush of water lifts and agitates the filter media 118, loosening the fines and particulates that have collected in between and on the filter media 118 during normal service. After a number of pulse sequences the controller 12 opens solenoid valve 17 for a set amount of time so the particulates loosened in the media 118 are flushed away via backwash drain 19.

It will be appreciated that the filter media grains 118 when lifted and dropped change position. When this happens any particulates that are in between the grains are loosened up and free to move. The constant or intermittent pulsing by the controller 12 allows this cycle of cleaning the filter media 118 to happen vigorously.

It will be understood that during the backwash cycle controller 12 may be preprogrammed to open and close solenoid valve 17 for the type of filter media 118 used. For example, FILOX may require more frequent and or intense backwashing than another filter media. Thus, controller 12 may be, for example, set or preprogrammed to cycle solenoid valve 17 for shorter pulses over a longer period of time than might be required for another filter media. The shorter pulses will allow for more inrush of water cycles and consequently more agitation of the filter media 118.

Referring also to FIG. 2A there is shown a graphical representation of the pulse backwash cycle in accordance with the invention shown in FIG. 1 and FIG. 2. As shown in FIGS. 2 and 2A, controller 12 initiates start backwash cycle at tₛₜₐᵣₜ by opening filter valve 14. The filter media 118 is flushed as described earlier for time tₒₙ₋₁. Flushing stops, i.e., filter valve 14 is turned off, for t_{off-1} allowing filter media to momentarily resettle. The on/off agitating flushing process is repeated for tₒₙ₋₂ and t_{off-2}. After t_{off-2} the controller 12 maintains flushing for a predetermined amount of time tᵣᵤₙ. It will be appreciated that particulates trapped in filter media 118 change position when vigorously agitated by the on/off flush pulsing. Thus, particulates that are trapped in filer media 118 are loosened and flushed during the vigorous pulse backwash cycle.

It will be understood that FIG. 2A illustrates a specific N=2 PRT cycles and tᵣᵤₙ time. It will be appreciated that the general form for calculating the pulse backwash cycle may be of the form:

Pulse Backwash Cycle=(Pulse Repetition Time (PRT) cycle*N)+tᵣᵤₙ, where
N=number of PRT cycles; and
tᵣᵤₙ=run time for continuous backwash.

Referring also to FIG. 2B there is shown a method flow chart for one method of determining the pulse backwash cycle shown in FIG. 2A. Step 2B1 sets tₒₙ₋₁ time and step 2B2 selects the number of tₒₙ₋₁ cycles. Likewise step 2B3 sets tₒₙ₋₂ time and step 2B4 selects the number of tₒₙ₋₂ cycles. Steps 2B5 sets the time and step 2B6 selects the number of t_{off-1} cycles. Step 2B7 sets the t_{off-2} time and step selects the number of t_{off-2} cycles. Step 2B9 sets the tᵣᵤₙ time. For clarity FIG, 2A only shows two flushing cycles; however, it will be appreciated that any suitable number of on/off cycles and durations may be selected to set the desired pulse backwash cycle as shown in FIG. 2A.

Referring also to FIG. 2C there is shown an alternate method flow chart for determining the pulse backwash cycle shown in FIG. 2A. Step 2C1 selects the filter media type, for example, FILOX or sand. Step 2C2 selects the number of duty cycles predetermined for the filter media type. It will be appreciated that within a pulse backwash cycle the duty cycles may be either periodic or aperiodic. Step 2C3 determines the overall pulse backwash cycle according to the number of duty cycles and the tᵣᵤₙ time for the selected media.

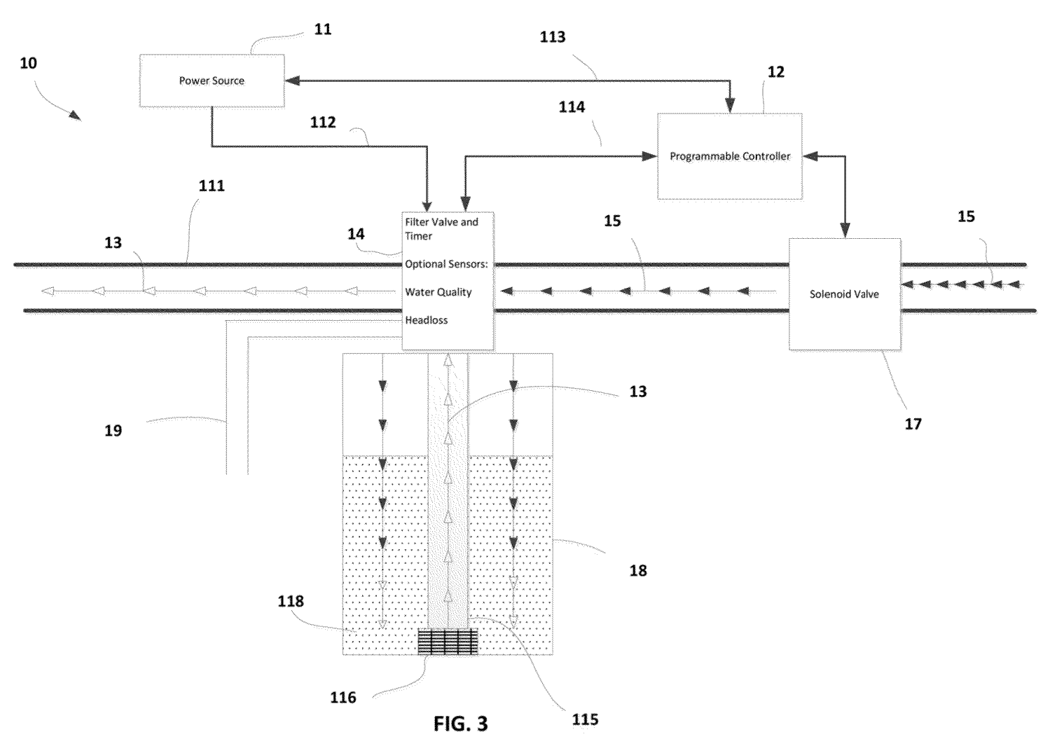

Referring also to FIG. 3, there is shown a pictorial illustration of pulsed backwash system 10 with optional sensors and in filter mode in which the invention is implemented in accordance with the invention shown in FIG. 1.

Sensors 14A, e.g., water quality and/or head-loss (e.g., pressure sensors), shown in filter valve and timer 14 may be used to signal controller 12 that a backwash cycle is needed. For example, if filter media 118 is clogged such that water flow through filter assembly 18 falls below a predetermined rate the sensor signals controller 12 that a backwash cycle is required. Similarly, a water quality sensor may also signal controller 12 that a backwash cycle is required when the water quality falls below a predetermined level. The water quality sensor may be any suitable sensor such as, for example, a chemical or bacterial sensor. Furthermore, sensors 14A may provide input to controller 12 for calculating pulse backwash cycle time.

It should he understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims. For example, the invention will also work in conjunction with a metered filter valve that will backwash the filter when a set amount of water has passed through the system. It will also be appreciated that the invention can be applied to all residential, commercial, and industrial applications.

What is claimed is:

1. A pulsed backwash apparatus (PBA) for pulsing backwash through a filter media during a pulse backwash cycle, the apparatus comprising:
the filter media;
a programmable controller;
a filter valve for controlling backwash direction; and
wherein the programmable controller initiates the pulse backwash cycle with a start backwash cycle command to the filter valve and stops the pulse backwash cycle with a stop backwash cycle command to the filter valve.

2. The PBA as in claim 1 wherein the pulse backwash cycle comprises:
a plurality of filter valve open period tₒₙ;
a plurality of filter Valve close period t_{off}; and
one filter valve open period tᵣᵤₙ.

3. The PBA as claim 1 further comprising a water quality sensor for signaling the programmable controller to initiate a pulse backwash cycle.

4. The PBA as in claim 1 further comprising a headloss sensor for signaling the programmable controller to initiate a pulse backwash cycle.

5. The PBA as in claim 1 further comprising a timer for determining the duration of the at least one filter valve open period tₒₙ.

6. A method for pulsing backwash through a filter media during a pulse backwash cycle, the method comprising;
selecting a filter media type;
providing a filter valve for controlling backwash flow direction; and
selecting a pulse repetition time (PRT) for pulsing backwash through the filter media via the filter valve.

7. A method as in claim 6 wherein selecting the PRT further comprises selecting the PRT in accordance with the filter media type.

8. A method as in claim 6 further comprising selecting a duty cycle for the filter media type;

9. A method as in claim 8 wherein selecting the duty cycle further comprises selecting the duty cycle in accordance with the filter media type.

10. A method as in claim 6 further comprising selecting a tᵣᵤₙ time for continuous backwash through the filter media via the filter valve.

11. A method as in claim 10 wherein selecting the tᵣᵤₙ time further comprises selecting tᵣᵤₙ time in accordance with the filter media type.

12. A method as in claim 6 further comprising selecting a pulse backwash cycle for the selected filter media type.

13. A method as in claim 12 wherein selecting a pulse backwash cycle for the selected filter media type further comprises:
determining a pulse repetition time (PRT);
determining a duty cycle;
determining a number of PRT cycles; and
determining a tᵣᵤₙ time for continuous backwash through the filter media via the lifter valve.

14. A method for determining a pulse backwash cycle time, the method comprising:
determining a filter media type;
receiving an input from a first sensor; and
calculating a pulse backwash cycle time based upon the filter media type and the input from the first sensor.

15. The method as in claim 14 wherein receiving an input from the first sensor further comprises receiving an input from a water quality sensor.

16. The method as in claim 14 wherein receiving an input from the first sensor further comprises receiving an input from a pressure sensor.

17. A method for determining a pulse backwash cycle, the method comprising:
selecting a filter type;
determining at least one first pulse repetition time (PRT) for the filter type determining a first duty cycle for the at least one first PRT;
determining at least one second PRT for the filter type;
determining a second duty cycle for the at least one second PRT; and
determining a tᵣᵤₙ time for the filter type.

18. The method as in claim 17 further comprising:
receiving a first sensor input; and
determining the pulse backwash cycle in accordance with the first sensor input.

19. The method as in claim 18 wherein receiving the first sensor input comprises receiving a water quality input.

20. The method as in claim 18 wherein receiving the first sensor input comprises receiving a water pressure input.
